(19) United States
(12) Patent Application Publication
(10) Pub. No.: US 2008/0206465 A1
(43) Pub. Date: Aug. 28, 2008

(54) AQUEOUS INKJET INK COMPOSITION

(76) Inventors: Gang C. Han-Adebekun, Center Valley, PA (US); Gary L. House, Victor, NY (US)

Correspondence Address: Andrew J. Anderson;Patent Legal Staff, Eastman Kodak Company, 343 State Street, Rochester, NY, 14650-2201, US

(21) Appl. No.: 12/029,909

(22) Filed: Feb. 12, 2008

Related U.S. Application Data
(60) Provisional application No. 60/892,137, filed on Feb. 28, 2007.

(51) Int. Cl. C08K 3/04; B05D 5/00

(52) U.S. Cl. 427/256; 524/1; 524/496

(57) ABSTRACT

An inkjet ink comprising water, a self-dispersing carbon black pigment, and a water soluble polymer containing acid groups neutralized by an inorganic base, wherein said carbon black pigment comprises greater than 11 weight % volatile surface functional groups. The inks of the present invention have improved print density on plain paper, good text quality, improved print durability such as waterfastness and excellent jetting performance over an extended printing period. They further provide good print uniformity over a wide variety of inkjet receivers.

### CROSS REFERENCE TO RELATED APPLICATIONS

This 35 USC 111A application claims the benefit of Provisional Application Ser. No. 60/892,137 filed Feb. 28, 2007, the disclosure of which is incorporated by reference herein in its entirety.

Reference is also made to commonly assigned, co-pending application Ser. No. ______ (based on Provisional Application Ser. No. 60/892,158 filed Feb. 28, 2007 (Kodak Docket 93606)) and ______ (based on Provisional Application Ser. No. 60/892,171 filed Feb. 28, 2007 (Kodak Docket 93607)) by Brust et al., and application Ser. No. ______ (based on Provisional Application Ser. No. 60/892,176 filed Feb. 28, 2007 (Kodak Docket 93631)) by Blease et al., filed of even date herewith.

### BACKGROUND OF THE INVENTION

Inkjet printing is a non-impact method for producing printed images by the deposition of ink droplets in a pixel-by-pixel manner to an image-recording element in response to digital data signals. There are various methods that may be utilized to control the deposition of ink droplets on the image-recording element to yield the desired printed image. In one process, known as drop-on-demand inkjet, individual ink droplets are projected as needed onto the image-recording element to form the desired printed image. Common methods of controlling the projection of ink droplets in drop-on-demand printing include piezoelectric transducers and thermal bubble formation. In another process, known as continuous inkjet, a continuous stream of droplets is charged and deflected in an image-wise manner onto the surface of the image-recording element, while un-imaged droplets are caught and returned to an ink sump. Inkjet printers have found broad applications across markets ranging from desktop document and photographic-quality imaging, to short run printing and industrial labeling.

The inks used in the various inkjet printers can be classified as either dye-based or pigment-based. A dye is a colorant that is dissolved in the carrier medium. A pigment is a colorant that is insoluble in the carrier medium, but is dispersed or suspended in the form of small particles. These small particles can be stabilized against flocculation and settling by the use of distinct dispersing agents such as surfactants, oligomers or polymers, or they can be directly functionalized to provide a self-dispersing characteristic. In either case the carrier medium can be a liquid or a solid at room temperature. Commonly used carrier media include water, mixtures of water and organic co-solvents and high boiling organic solvents, such as hydrocarbons, esters, ketones, alcohols and ethers.

Pigment-based inkjet inks are often preferred over dye-based inkjet inks because of the superior image stability typically observed with the pigment-based inks. Self-dispersed pigments in turn are often preferred over surfactant-dispersed, oligomer-dispersed or polymer-dispersed pigments because of their greater stability to a variety of ink formulations and environmental keeping conditions.

Key attributes for inkjet printing on plain papers include high print density, sharp text quality and high print durability such as high resistance to water, rub and highlighter smear for the printed document on plain paper. Equally important is printing quality uniformity across a large variety of plain papers. It is well known that the performance of inkjet printing on plain paper is very sensitive to paper type. Paper type in turn is affected by the paper formulation (e.g. size agent type and amount, filler type and amount, etc.), the manufacturing process, and paper pulp variation. It is highly desirable to have ink formulations that can provide excellent and uniform print quality with low paper to paper variability. In addition, jetting performance of the ink is equally important. This includes, for example, forming stable drops, robust jetting at the desired firing frequency, and maintaining the jetting performance, e.g. constant drop velocity during the extended print head life cycle. Inks containing self-dispersed pigments have to date failed to provide all the desired attributes of an ink-jet ink intended for use on plain papers.

Various improvements have been proposed by workers in the field. U.S. Pat. No. 5,846,307 and JP 2003-171590 both described an ink containing a self-dispersed carbon black with an organic base neutralized water soluble polymer. However, due to the interaction with print head materials such as the heater surface in a thermal inkjet printer, such polymers may cause severe degradation in jetting performance. U.S. Pat. No. 5,571,311A, US 20050020730A1 and U.S. Pat. No. 6,329,446 all described an ink containing a self-dispersed carbon black and a water soluble polymer. However, the self-dispersed carbon black dispersion comprises low level of volatile surface functional groups, which leads to undesirable plain paper performance such as high paper-to-paper variability. U.S. Pat. No. 6,866,379 discloses use of water soluble polymers having acid groups neutralized by an alkali metal hydroxide in pigment-based inkjet inks results in improved physical durability such as scratch and smudging resistance while maintaining reliable jetting from inkjet printheads. It has been found, however, that addition of water soluble polymers to inkjet inks comprising some self-dispersing carbon black pigments results in an undesirable reduction in print density.

There is a need to provide a pigmented ink composition comprising self-dispersing carbon black which can provide high print density and text sharpness on plain paper with low variability across a wide range of plain papers. Additionally, there is a need for such ink compositions which, when employed in inkjet printing processes, exhibit stable long-term drop velocity and robust printing in a printer system.

### SUMMARY OF THE INVENTION

In accordance with a first embodiment, the invention is directed towards an inkjet ink comprising water, a self-dispersing carbon black pigment, and a water soluble polymer containing acid groups neutralized by an inorganic base, wherein said carbon black pigment comprises greater than 11 weight % volatile surface functional groups. The inks of the present invention have improved print density on plain paper, good text quality, improved print durability such as waterfastness and excellent jetting performance over an extended printing period. They further provide good print uniformity over a wide variety of inkjet receivers.

### DETAILED DESCRIPTION OF THE INVENTION

A self-dispersing pigment means a pigment that retains a state stably dispersed in a liquid carrier medium, such as water, a water-soluble organic solvent or a liquid mixture thereof without requiring use of any dispersing agent such as a water-soluble polymeric compound. It further does not generate aggregates among pigment particles which may interfere with normal ink ejection from orifices using an ink-jet printing technique. In general, there exists two classes of self-dispersing pigments. The first class has a charged (also called hydrophilic) group being bonded directly to the surface of the pigment, and the second class has a charged group being bonded through a linking group to the surface of the pigment.

The first class of self-dispersed pigment is preferably, for example, a pigment in which at least one charged group, such as anionic group, has been bonded directly to the surface of the pigment. Preparation of such pigments is well known in the art. Karl, et al., in U.S. Pat. No. 6,503,311 B1 and Yeh et al., in U.S. Pat. No. 6,852,156 B2, have described anionic self-dispersed pigments prepared by ozone oxidation. Ito et al, in U.S. Pat. No. 6,488,753 B1 and Momose et al., in EP 1,479,732 A1, describe anionic self-dispersed pigments prepared by hypochlorite oxidation. Related disclosures occur in U.S. Pat. Nos. 5,609,671, 5,846,307, 5,861,447, 6,099,632, and 6,468,342. The above disclosures are incorporated herein by reference. Additional peroxo acid oxidations methods are disclosed in JP 2004-230134, JP 2004-107513, JP 2004-224955 and JP 2003-183541. Papirer et al., Carbon, Vol. 34, No. 12, pages 1521 to 1529 (1996) discloses and reviews several additional methods of direct functionalization of carbon surfaces. When applied to pigments, these procedures introduce surface bound hydrophilic or charged groups on the pigment to form self-dispersing pigments comprising a hydrophilic group bonded directly to the surface thereof that are suitable for use in an ink-jet ink.

More specifically, this surface-modified carbon black may be prepared by grafting a functional group or a molecule containing a functional group onto the surface of carbon black by physical treatment, such as vacuum plasma, or chemical treatment (for example, oxidation with hypochlorous acid, sulfonic acid or the like). According to the present invention, the surface-modified pigment is preferably one produced by a method involving wet oxidation with a hypohalous acid or a salt thereof. Hypohalous acids or salts thereof include sodium hypochlorite, potassium hypochlorite, sodium hypobromite, and potassium hypobromite. Among them, sodium hypochlorite is particularly preferred from the viewpoints of reactivity and cost. Specifically, the method involving wet oxidation with a hypohalous acid or a salt thereof may be carried out as follows.

A pigment and a surface modifier (for example, sodium hypochlorite) are heated and dispersed or stirred in a suitable amount of water. For example, a ball mill, an attritor, a colloid mill, or a sand mill with glass, zirconia, alumina, stainless steel, magnetic or other beads added thereto may be used for stirring. In this case, preferably, the pigment may be previously ground to a desired particle size. Alternatively, the pigment may be reacted with the surface modifier while grinding the pigment. The grinding may be carried out by means of a rotary homogenizer or an ultrasonic homogenizer. Beads and coarse particles are separated from the dispersion after stirring and oxidation, followed by the removal of by-products of the oxidizing agent to perform purification. Thus, an aqueous pigment dispersion is obtained. If necessary, for example, concentration by a separation membrane or the like, filtration through a metallic filter or a membrane filter, classification by centrifugation, or neutralization with a hydroxide of an alkali metal salt or an amine may be carried out. A modified carbon black produced by the hypohalous oxidation method generally as described by Ito et al., in U.S. Pat. No. 6,488,753 B1 and related publications has a high surface carboxylic acid content. As a result, the dispersibility of the modified carbon black in water is very high. Commercially available products may be used as the above pigment, and preferred examples thereof include Bonjet CW-1, Bonjet CW-2 and Bonjet CW-3 manufactured by Orient Chemical Industries, Ltd, and Aquablack 162 and Aquablack 164 from Tokai Carbon Co.

The second class of self-dispersed pigment is a pigment in which at least one hydrophilic group, such as an anionic group or cationic group, has been bonded through a linking group to the pigment surface. Generally, a chemical modification is commonly applied in the process. Bergemann, et al., in U.S. Pat. No. 6,758,891 B2 describe the covalent functionalization of pigments by reaction with organic triazoles. Bergemann, et al., in U.S. Pat. No. 6,660,075 B2 further describe the covalent functionalization of pigments by reaction with unsaturated organic compounds. Belmont in U.S. Pat. No. 5,554,739, Adams and Belmont in U.S. Pat. No. 5,707,432, Johnson and Belmont in U.S. Pat. Nos. 5,803,959 and 5,922,118 and in published applications WO 96/18695, WO 96/18696, WO 96/18689, WO 99/51690, WO 00/05313, and WO 01/51566 describe the covalent functionalization of pigments with diazonium compounds. Like preparations of covalently functionalized self-dispersed pigments are additionally described by Osumi et al., in U.S. Pat. No. 6,280,513 B1 and U.S. Pat. No. 6,506,239 B1. Karl et al in U.S. Pat. No. 6,780,389 describe related diazonium induced surface attachment preparations. The disclosures of the above patents are incorporated herein by reference. These publications further describe the preparation and use of ink-jet inks employing the described self-dispersed pigments. Both anionic and cationic self-dispersed pigments are described. Papirer et al., Carbon, Vol. 34, No. 12, pages 1521 to 1529 (1996) discloses and reviews several additional methods of direct functionalization of carbon surfaces. When applied to pigments, these procedures introduce hydrophilic or charged groups on the pigment to form a self-dispersed pigment comprising a hydrophilic or charged group bonded through a linking group to the surface thereof suitable for use in ink-jet ink. Preferred linking groups are optionally substituted aliphatic groups having 2 to 8 carbon atoms and optionally substituted aromatic groups having 6 to 14 carbon atoms. Phenyl groups are particularly useful as linking groups. Preferred anionic charged groups are chosen from the group consisting of carboxylic, phosphonic, boronic and sulfonic acid groups. Preferred cationic charged groups are chosen from the group consisting of optionally substituted ammonium and phosphonium groups.

One preferred method is treatment of, for example, a carbon black pigment with aryl diazonium salts containing at least one acidic functional group. Examples of aryl diazonium salts include those prepared from sulfanilic acid, 4-aminobenzoic acid, 4-aminosalicylic acid, 7-amino-4-hydroxy-2-naphthylenesulfonic acid, aminophenyl-boronic acid, aminophenylphosphonic acid, and metalinic acid. Ammonium, quaternary ammonium groups, quaternary phosphonium groups, and protonated amine groups represent examples of cationic groups that can be attached to the same organic groups discussed above. Self-dispersing pigments of this class are also commercially available from Cabot as Cab-O-Jet® 200 and Cab-O-Jet® 300. While both anionic and cationic charged self-dispersed pigments are known and can be employed in the practice of the invention, anionic, i.e. negatively charged self-dispersed pigments are preferred.

The following water-insoluble pigments are among those useful as substrates suitable for chemical modification as described previously into the pigments in the practice of the invention; however, this listing is not intended to limit the invention. The following pigments are available from Cabot: Monarch® 1400, Monarch® 1300, Monarch® 1100, Monarch® 1000, Monarch® 900, Monarch® 880, Monarch® 800, and Monarch® 700. The following pigments are available from Ciba-Geigy: Igralite® Rubine 4BL. The following pigments are available from Columbian: Raven 7000, Raven 5750, Raven 5250, Raven 5000, and Raven 3500. The following pigments are available from Degussa: Color Black FW 200, Color Black FW 2, Color Black FW 2V, Color Black FW 1, Color Black FW 18, Color Black S 160, Color Black S 170, Special Black: 6, Special Black 5, Special Black 4A, Special Black 4, Printex U, Printex V, Printex 140U, and Printex 140V. The following pigment is available from DuPont: Tipure® R-101. The following pigment is available from Hoechst: Permanent Rubine F6B. The following pigment is available from Sun Chemical: LHD9303 Black.

The surface chemistry of the carbon surface after treatment affects its performance on plain paper. Since all carbon blacks have chemisorbed oxygen complexes (i.e., carboxylic, quinonic, lactonic, or phenolic groups) on their surfaces to varying degrees depending on the surface treatment conditions and mechanism. One way to characterize the amount of the total surface groups as well as the types of the surface groups (i.e., lactonic vs. carboxylic) is through the measurement of volatile surface functional groups. Thermogrametric analysis (TGA) is used to obtain such information by monitoring the weight change that occurs as the carbon black dispersion sample is being heated.

Specifically, volatile surface functional group and wt % volatile lactonic functional group are obtained following the 5 steps as described below:

Step 1) 95 mls of Reagent grade acetonitrile is added to the 5 mls of carbon black dispersion. This destabilizes the pigment suspension fairly rapidly.

Step 2) Collect the pigment cake by centrifugation at 7500 RPM for 1 hour and place it in a vacuum oven at 80 degree C. for 16 hours.

Step 3) Place the pigment cake on the sample pan of a standard TGA oven to collect the weight loss using the following scan conditions: 1^{st} temperature range: 25° C. to 700° C., with Nitrogen as the purge gas at a rate of 60 vv/min to the TGA oven and 40 cc/min to the TGA balance. The heating rate is 10° C./min. From the temperature range of 700° C. to 1000° C., switch to air at the same flow rate, with a heating rate of 10° C./min. % of weight loss is recorded during the entire temperature scan range of 25° C. to 1000° C.

Step 4) Calculate the total weight % of volatile surface functional group on the carbon black dispersion surface by the following equation: wt % volatile surface functional group=(weight loss 125° C.→700° C.)/(weight loss 125° C.→700° C.+weight loss 700° C.→805° C.). This is based on the physical understanding during the decomposition of carbon black pigment cake: weight losses before 125° C. are due to the volatile component in the sample; weight losses between 125° C. and 700° C. are associated with surface functional group on the carbon black dispersion particles; weight losses between 700° C. and 805° C. with the air as purge gas is due to the decomposition of carbon black through combustion.

Step 5) Calculate the weight % of lactone functional group on the carbon black dispersion surface using the following equation: wt % volatile lactonic functional group=(weight loss 125° C.→400° C.)/(weight loss 125° C.→700° C.+weight loss 700° C.→805° C.). This is based on the results from pyrolytic gas chromatograph indicating that lactone groups decomposes around 358° C. and carboxyl groups decomposes around 650° C.

The self-dispersing carbon black pigments employed in the present invention have a volatile surface functional group content greater than about 11 weight %, more preferably greater than 15%, and most preferably greater than 18%. Furthermore, it is preferred that the pigment has a volatile lactonic functional group content greater than about 5%. Pigments possessing these features have been found to provide improved print density on plain papers, good text quality, improved print durability such as waterfastness and excellent jetting performance over an extended printing period. They further provide good print uniformity over a wide variety of inkjet receivers.

The self-dispersing carbon black pigments of the present invention preferably contains anionic groups which are neutralized with a inorganic metal cation selected from sodium, potassium, lithium and rubidium.

The self-dispersing carbon black pigments of the present invention preferably have a median effective particle diameter from about 55 nm to about 200 nm, preferably 55 to 170 nm and more preferably 55 to 140 mm. As used herein, median particle diameter refers to the 50th percentile such that 50% of the volume of the particles is composed of particles having diameters smaller than the indicated diameter. It is understood the pigment dispersion of the invention are composed of aggregates of primary carbon black smaller than the mean particle diameter from above. Typical primary particle sizes of the carbon black particles comprising the pigment dispersion may be in the range of 10 nm to 30 nm. The median particle diameter in the present invention is measured by using a Microtrac Ultrafine Particle Analyzer (UPA) 150 from Microtrac, Inc.

### Polymer

The polymers used in this invention are commonly known as water-reducible resins, which are polymers having hydrophilic groups in at least some monomers. The polymer is not water-soluble until neutralized by base. By the term “water-soluble” is meant herein that when the polymer is dissolved in water and when the polymer is at least partially neutralized with base the resultant solution is visually clear. Acid number is a common term used to indicate the amount of acid group in a polymer, it is defined as mg of KOH required to neutralize 1 g of resin solids.

The monomers for the polymer employed in the ink of the invention can be selected from methyl methacrylate, ethyl methacrylate, butyl methacrylate, ethyl acrylate, butyl acrylate, hexyl acrylate, n-octyl acrylate, lauryl methacrylate, 2-ethylhexyl methacrylate, nonyl acrylate, benzyl methacrylate, 2-hydroxypropyl methacrylate, acrylonitrile, methacrylonitrile, vinyl acetate, vinyl propionate, vinylidene chloride, vinyl chloride, styrene, α-methyl styrene, t-butyl styrene, vinyl toluene, butadiene, isoprene, N,N-dimethyl acrylamide, acrylic acid, methacrylic acid, chloromethacrylic acid, maleic acid and derivatives thereof. Examples of suitable monomers include allyl compounds such as allyl esters (e.g., allyl acetate, allyl caproate, etc.); vinyl ethers (e. g., methyl vinyl ether, butyl vinyl ether, methoxyethyl vinyl ether, ethoxyethyl vinyl ether, chloroethyl vinyl ether, 1-methyl-2,2-dimethylpropyl vinyl ether, hydroxyethyl vinyl ether, diethylene glycol vinyl ether, dimethylaminoethyl vinyl ether, butylaminoethyl vinyl ether, benzyl vinyl ether, tetrahydrofurfuryl vinyl ether, etc.); vinyl esters (such as vinyl acetate, vinyl propionate, vinyl butyrate, vinyl isobutyrate, vinyl dimethyl propionate, vinyl ethyl butyrate, vinyl chloroacetate, vinyl dichloroacetate, vinyl methoxyacetate, vinyl phenyl acetate, vinyl acetoacetate, etc.); vinyl heterocyclic compounds (such as N-vinyl oxazolidone, N-vinylimidazole, N-vinylpyrrolidone, N-vinylcarbazole, vinyl thiophene, N-vinylethyl acetamide, etc.); styrenes (e.g, styrene, divinylbenzene, methylstyrene, dimethylstyrene, ethylstyrene, isopropylstyrene, sodium styrenesulfonate, potassium styrenesulfinate, butylstyrene, hexylstyrene, cyclohexylstyrene, benzylstyrene, chloromethylstyrene, trifluoromethylstyrene, acetoxymethylstyrene, acetoxystyrene, vinylphenol, (t-butoxycarbonyloxy)styrene, methoxystyrene, 4-methoxy-3-methylstyrene, dimethoxystyrene, chlorostyrene, dichlorostyrene, trichlorostyrene, bromostyrene, iodostyrene, fluorostyrene, methyl vinylbenzoate ester, vinylbenzoic acid, etc.); crotonic acids (such as crotonic acid, crotonic acid amide, crotonate esters (e.g., butyl crotonate, etc.)); vinyl ketones (e.g., methyl vinyl ketone, etc); olefins (e.g., dicyclopentadiene, ethylene, propylene, 1-butene, 5,5-dimethyl-1-octene, etc.); itaconic acids and esters (e.g., itaconic acid, methyl itaconate, etc.), other acids such as sorbic acid, cinnamic acid, methyl sorbate, citraconic acid, chloroacrylic acid mesaconic acid, maleic acid, fumaric acid, and ethacrylic acid; halogenated olefins (e.g., vinyl chloride, vinylidene chloride, etc.); unsaturated nitriles (e.g., acrylonitrile, etc.); acrylic or methacrylic acids and esters (such as acrylic acid, methyl acrylate, methacrylic acid, methyl methacrylate, ethyl acrylate, butyl acrylate, butyl methacrylate, 2-hydroxyethyl methacrylate, 2-acetoacetoxyethyl methacrylate, sodium-2-sulfoethyl acrylate, 2aminoethylmethacrylate hydrochloride, glycidyl methacrylate, ethylene glycol dimethacrylate, etc.); and acrylamides and methacrylamides (such as acrylamide, methacrylamide, N-methylacrylamide, N,N-dimethylacrylamide, N-isopropylacrylamide, N-s-butylacrylamide, N-t-butylacrylamide, N-cyclohexylacrylamide, N-(3-aminopropyl)methacrylamide hydrochloride, N-(3-dimethylaminopropyl)methacrylamide hydrochloride, N,N-dipropylacrylamide, N-(1,1-dimethyl-3-oxobutyl)acrylamide, N-(1,1,2-trimethylpropyl)acrylamide, N-(1,1,3,3-tetramethylbutyl)acrylamide, N-(1-phthalamidomethyl)acrylamide, sodium N-(1,1-dimethyl-2-sulfoethyl)acrylamide, N-butylacrylamide, N-(1,1-dimethyl-3-oxobutyl)acrylamide, N-(2-carboxyethyl)acrylamide, 3-acrylamido-3-methylbutanoic acid, methylene bisacrylamide, etc.).

The polymer employed in this invention can be prepared by emulsion polymerization, solution polymerization or bulk polymerization technique well known in the art. Furthermore, the polymer preferably has a weight average molecular weight of 2,000 to 100,000, more preferably 4,000 to 40,000. The polymer preferably has an acid number of 50 to 400, more preferably 100 to 300, and most preferably 130 to 300. The acid groups on the polymer are neutralized by an inorganic base, preferably an alkaline metal hydroxide, such as potassium hydroxide, sodium hydroxide or lithium hydroxide. The percentage of acid groups on the polymer are neutralized such that, preferably 75% to 100% of the groups are neutralized by alkaline metal hydroxide. Polymers of the present invention are exemplified by those disclosed in U.S. Pat. No. 6,866,379, which is incorporated herein in its entirety by reference. The addition polymer used in the invention is present in the inkjet ink generally from about 0.1% to about 20% by weight, preferably from about 0.2% to about 15% by weight based on the total weight of the ink.

Preferred water-soluble polymers useful in the present invention are copolymers prepared from at least one hydrophilic monomer that is an acrylic acid or methacrylic acid monomer, or combinations thereof. Preferably, the hydrophilic monomer is methacrylic acid. In one embodiment the hydrophilic monomer is present in the copolymer in an amount of at least 15%, more preferably at least 25%.

Preferred water-soluble polymers useful in the present invention are copolymers prepared from at least one hydrophobic monomer that is an (meth)acrylic acid ester. The hydrophobic monomer may be selected from methacrylic acid esters, or acrylic acid esters. Examples of hydrophobic monomers include, methyl(meth)acrylate, ethyl(meth)acrylate, butyl(meth)acrylate, octyl(meth)acrylate, decyl(meth)acrylate, lauryl(methacrylate), stearyl(meth)acrylate, benzyl(meth)acrylate, phenyl(meth)acrylate or combinations thereof. A preferred hydrophobic monomer is benzyl(meth)acrylate.

The water-soluble polymer may also be a styrene-acrylic copolymer comprising a mixture of vinyl or unsaturated monomers, including at least one styrenic monomer and at least one acrylic monomer, at least one of which monomers has an acid or acid-providing group. Such polymers are disclosed in, for example, U.S. Pat. Nos. 4,529,787; 4,358,573; 4,522,992; 4,546,160; the disclosures of which are incorporated herein by reference. Preferred polymers include, for example, styrene-acrylic acid, styrene-acrylic acid-alkyl acrylate, styrene-maleic acid, styrene-maleic acid-alkyl acrylate, styrene-methacrylic acid, styrene-methacrylic acid-alkyl acrylate, and styrene-maleic acid half ester, wherein each type of monomer may correspond to one or more particular monomers. Examples of preferred polymers include but are not limited to styrene-acrylic acid copolymer, (3-methyl styrene)-acrylic acid copolymer, styrene-methacrylic acid copolymer, styrene-butyl acrylate-acrylic acid terpolymer, styrene-butyl methacrylate-acrylic acid terpolymer, styrene-methyl methacrylate-acrylic acid terpolymer, styrene-butyl acrylate-ethyl acrylate-acrylic acid tetrapolymer and styrene-(α-methylstyrene)-butyl acrylate-acrylic acid tetrapolymer.

The polymer of the present invention is not limited in the arrangement of the monomers comprising the copolymer. The arrangement of monomers may be totally random, or they may be arranged in blocks such as AB or ABA wherein, A is the hydrophobic monomer and B is the hydrophilic monomer. In addition, the polymer make take the form of a random terpolymer or an ABC triblock wherein, at least one of the A, B and C blocks is chosen to be the hydrophilic monomer and the remaining blocks are hydrophobic blocks dissimilar from one another. Preferably the copolymer is a random copolymer due to the ease of synthesis of such polymers.

### Surfactants

Surfactants may be added to adjust the surface tension of the ink to an appropriate level. The surfactants may be anionic, cationic, amphoteric or nonionic and used at levels of 0.01 to 5% of the ink composition. Examples of suitable nonionic surfactants include, linear or secondary alcohol ethoxylates (such as the Tergitol® 15-S and Tergitol® TMN series available from Union Carbide and the Brij® series from Uniquema), ethoxylated alkyl phenols (such as the Triton® series from Union Carbide), fluoro surfactants (such as the Zonyls® from DuPont; and the Fluorads® from 3M), fatty acid ethoxylates, fatty amide ethoxylates, ethoxylated and propoxylated block copolymers (such as the Pluronic® and Tetronic® series from BASF, ethoxylated and propoxylated silicone based surfactants (such as the Silwet® series from CK Witco), alkyl polyglycosides (such as the Glucopons® from Cognis) and acetylenic polyethylene oxide surfactants (such as the Surfynols from Air Products).

Examples of anionic surfactants include; carboxylated (such as ether carboxylates and sulfosuccinates), sulfated (such as sodium dodecyl sulfate), sulfonated (such as dodecyl benzene sulfonate, alpha olefin sulfonates, alkyl diphenyl oxide disulfonates, fatty acid taurates and alkyl naphthalene sulfonates), phosphated (such as phosphated esters of alkyl and aryl alcohols, including the Strodex® series from Dexter Chemical), phosphonated and amine oxide surfactants and anionic fluorinated surfactants. Examples of amphoteric surfactants include; betaines, sultaines, and aminopropionates. Examples of cationic surfactants include; quaternary ammonium compounds, cationic amine oxides, ethoxylated fatty amines and imidazoline surfactants. Additional examples are of the above surfactants are described in “McCutcheon's Emulsifiers and Detergents: 1995, North American Editor”.

Jet velocity, separation length of the droplets, drop size and stream stability are greatly affected by the surface tension and the viscosity of the ink. The inkjet inks suitable for use with inkjet printing systems and to apply to non-absorbing substrates, especially high surface energy hydrophobic surfaces, should have a surface tension in the range of about 20 dynes/cm to about 60 dynes/cm and, more preferably, in the range 20 dynes/cm to about 50 dynes/cm. Control of surface tensions in aqueous inks is accomplished by additions of small amounts of surfactants. The level of surfactants to be used can be determined through simple trial and error experiments, usually about 0.01% to about 6%, preferably, 0.1% to about 2% by weight of the total ink composition. Anionic, cationic and nonionic surfactants may be selected from those disclosed in U.S. Pat. Nos. 5,324,349; 4,156,616 and 5,279,654 as well as many other surfactants known in the inkjet ink art. Commercial surfactants include the Surfynols® from Air Products; the Zonyls® from DuPont and the Fluorads® from 3M.

The ink preferably has physical properties compatible with a wide range of ejecting conditions, i.e., driving voltages and pulse widths for thermal inkjet printing devices, driving frequencies of the piezo element for either a drop-on-demand device or a continuous device, and the shape and size of the nozzle. The exact choice of ink components will depend upon the specific application and performance requirements of the print head from which they are jetted. Thermal and piezoelectric drop-on-demand print heads and continuous print heads each require ink compositions with a different set of physical properties in order to achieve reliable and accurate jetting of the ink, as is well known in the art of inkjet printing. Acceptable viscosities are typically no greater than 20 cP, and preferably in the range of about 1.0 to 6.0 cP and most preferably in the range of 1.5 and 3 cP. The inkjet inks useful in the invention typically exhibit a solution density of between 1 and 1.2 g/cc.

A biocide (0.01-1.0% by weight) may also be added to prevent unwanted microbial growth which may occur in the ink over time. A preferred biocide for the inks employed in the present invention is Proxel® GXL (Zeneca Colours Co.) at a concentration of 0.05-0.1% by weight or/and Kordek® (Rohm and Haas Co.) at a concentration of 0.05-0.1% by weight (based on 100% active ingredient. Additional additives which may optionally be present in an inkjet ink composition include thickeners, conductivity enhancing agents, anti-kogation agents, drying agents, waterfast agents, dye solubilizers, chelating agents, binders, light stabilizers, viscosifiers, buffering agents, anti-mold agents, anti-curl agents, stabilizers and defoamers.

The pH of the aqueous ink compositions of the invention may be adjusted by the addition of acids or bases. Useful inks may have a preferred pH of from about 4 to 10, depending upon the type of pigment being used. Preferably, the pH of the present ink is from 5 to 9, more preferably from 6 to 8. Typical inorganic acids include hydrochloric, phosphoric and sulfuric acids. Typical organic acids include methanesulfonic, acetic and lactic acids. Typical inorganic bases include alkali metal hydroxides and carbonates. Typical organic bases include ammonia, triethanolamine and tetramethylethlenediamine.

Ink compositions useful in the invention may include humectants and/or co-solvents in order to prevent the ink composition from drying out or crusting in the nozzles of the printhead, aid solubility of the components in the ink composition, or facilitate penetration of the ink composition into the image-recording element after printing. Representative examples of humectants and co-solvents used in aqueous-based ink compositions include (1) alcohols, such as methyl alcohol, ethyl alcohol, n-propyl alcohol, isopropyl alcohol, n-butyl alcohol, sec-butyl alcohol, t-butyl alcohol, iso-butyl alcohol, furfuryl alcohol, and tetrahydrofurfuryl alcohol; (2) polyhydric alcohols, such as ethylene glycol, diethylene glycol, triethylene glycol, tetraethylene glycol, propylene glycol, polyethylene glycol, polypropylene glycol, 1,2-propane diol, 1,3-propane diol, 1,2-butane diol, 1,3-butane diol, 1,4-butane diol, 1,2-pentane diol, 1,5-pentanediol, 1,2-hexanediol, 1,6-hexane diol, 2-methyl-2,4-pentanediol, 1,2-heptane diol, 1,7-hexane diol, 2-ethyl-1,3-hexane diol, 1,2-octane diol, 2,2,4-trimethyl-1,3-pentane diol, 1,8-octane diol, glycerol, 1,2,6-hexanetriol, 2-ethyl-2-hydroxymethyl-propane diol, saccharides and sugar alcohols and thioglycol; (3) lower mono- and di-alkyl ethers derived from the polyhydric alcohols; such as, ethylene glycol monomethyl ether, ethylene glycol monobutyl ether, ethylene glycol monoethyl ether acetate, diethylene glycol monomethyl ether, diethylene glycol monobutyl ether, polyethylene glycol monobutyl ether and diethylene glycol monobutyl ether acetate; (4) nitrogen-containing compounds such as urea, 2-pyrrolidone, N-methyl-2-pyrrolidone, and 1,3-dimethyl-2-imidazolidinone; and (5) sulfur-containing compounds such as 2,2′-thiodiethanol, dimethyl sulfoxide and tetramethylene sulfone. Typical aqueous-based ink compositions useful in the invention may contain, for example, the following components based on the total weight of the ink: water 20-95%, humectant(s) 5-70%, and co-solvent(s) 2-20%.

Inkjet printing is a non-impact method for producing printed images by the deposition of ink droplets in a pixel-by-pixel manner to an image-recording element in response to digital data signals. There are various methods that may be utilized to control the deposition of ink droplets on the image-recording element to yield the desired printed image. In one process, known as drop-on-demand inkjet, individual ink droplets are projected as needed onto the image-recording element to form the desired printed image. Common methods of controlling the projection of ink droplets in drop-on-demand printing include piezoelectric transducers and thermal bubble formation. In another process, known as continuous inkjet, a continuous stream of droplets is charged and deflected in an image-wise manner onto the surface of the image-recording element, while un-imaged droplets are caught and returned to an ink sump. Inkjet printers have found broad applications across markets ranging from desktop document and photographic-quality imaging, to short run printing and industrial labeling. Inkjet printing methods, and related printers, are commercially available and need not be described in detail. In one embodiment the inks of the current invention are preferably utilized in a thermal printer.

The inks of the invention are preferably utilized in an inkjet set comprising at least magenta, cyan, yellow and black inks. Colorless ink compositions that contain non-colored particles and no colorant may also be used. Colorless ink compositions are often used in the art as “fixers” or insolubilizing fluids that are printed under, over, or with colored ink compositions in order to reduce bleed between colors and waterfastness on plain paper; see for example, U.S. Pat. No. 5,866,638 or U.S. Pat. No. 6,450,632 B1. Colorless inks are also used to provide an overcoat to a printed image, usually in order to improve scratch resistance and waterfastness; see for example, U.S. 2003/0009547 A1 or E.P. 1,022,151 A1. Colorless inks are also used to reduce gloss differential in a printed image; see for example, U.S. Pat. No. 6,604,819 B2; U.S. 2003/0085974 A1; U.S. 2003/0193553 A1; or U.S. 2003/0189626 A1. In a particular embodiment, the self-dispersing carbon black pigment ink of the invention may be employed in an ink set further comprising pigment-based cyan, magenta, and yellow inks and a colorless protective ink, wherein the relative dynamic and static surface tensions of various pigment based inks and colorless protective ink of the ink set are controlled to control intercolor bleed between the inks as described in copending, commonly assigned U.S. Ser. No. ______ (based on Provisional Application Ser. No. 60/892,176 filed Feb. 28, 2007 (Kodak Docket 93631)), the disclosure of which is incorporated by reference herein. Pigment-based inks employed in such an ink set may further advantageously comprise water-soluble acrylic type polymeric additives and water dispersible polycarbonate-type or polyether-type polyurethanes as described in copending, commonly assigned U.S. Ser. Nos. ______ and ______ (based on Provisional Application Ser. Nos. 60/892,158 and 60/892,171 filed Feb. 28, 2007 (Kodak Dockets 93606 and 93607)), the disclosures of which are incorporated by reference herein.

The process of the present invention can be employed with a wide variety of recording media, including plain papers such as Xerox® 4024 papers, including Ashdown 4024 DP, Cortland 4024 DP, Champion 4024 DP, Xerox® 4024 D.P. green, Xerox® 4024 D.P. pink, Xerox® 4024 D.P yellow, and the like, Xerox® 4200 papers, Xerox® 10 series paper, Xerox® Imaging Series LX paper, canary ruled paper, ruled notebook paper, bond paper such as Gilbert 25 percent cotton bond paper, Gilbert 100 percent cotton bond paper, and Strathmore bond paper, recycled papers, silica coated papers such as Sharp Company silica coated paper, Jujo® paper, Georgia-Pacific inkjet Paper Catalog Number 214305N, Kodak bright white inkjet paper, Hewlett Packard Color inkjet paper, Xerox Extra Bright white inkjet paper, Georgia-Pacific inkjet Paper Catalog Number 999013, Staples inkjet paper, International Paper Great White MultiUse 20 Paper, 8) Xerox Premium Multipurpose Paper, Hammermill Copy plus or ForeMP paper, and Hewlett Packard Multipurpose paper, glossy papers, and the like, transparency materials such as Xerox® 3R3351 inkjet transparencies, Tetronix inkjet transparencies, Arkright inkjet transparencies, Hewlett-Packard inkjet transparencies, and the like, fabrics, textile products, plastics, polymeric films, inorganic substrates such as metals and wood, and the like.

The following examples illustrate, but do not limit, the utility of the present invention.

### EXAMPLES

### Polymer Binder Preparation

### Polymer Binder A-1

In a 1-liter, three-necked round-bottom flask equipped with a reflux condenser were mixed under nitrogen atmosphere 78 g of benzyl methacrylate, 22 g of methacrylic acid, 4.6 g of 1-dodecanethiol, and 400 mL of methyl ethyl ketone. The solution was stirred and purged with nitrogen for 20 minutes and heated to 70° C. in a constant temperature bath; 1.5 g. of Azobisisobutyronitrile (AIBN) was added. After 24 hours, the resulting solution was cooled. The resulting polymer solution was mixed with water and potassium hydroxide to achieve 85% acid neutralization. Thereafter the whole mixture was distilled at 50° C. under reduced pressure to remove the organic solvent. The final water-soluble polymer solution had a concentration of ca. 20 wt. % in water and its pH was ca. 8.5. The number average molecular weight was 4320 and the weight average molecular weight was 7160, and the calculated acid number was 146.

### Polymer Binder A-2

A-2 was prepared like A-1 except that 67 g of benzyl methacrylate, 33.0 g of methacrylic acid, 1.7 g of AIBN and 4.5 g of 1-dodecanethiol were used. The number average molecular weight was 5040 and the weight average molecular weight was 8860, and the acid number was 215. The final polymer is 85% neutralized by potassium hydroxide to provide a water-soluble polymer at an concentration of ca. 20 wt. % in water.

### Polymer Binder A-3

About 100 g of A-1 solution was slowly added to 1 liter of 1% HCl solution with sting. A white precipitate was formed immediately and stirring was continued for 10 minutes. The precipitates were collected by filtration and washed with DI water till pH ˜5 (by pH paper). The precipitate was then dried in vacuum at 60 degree C. overnight. To make water-soluble polymer solution A-3, 20 g of dried A-1 powder, 4.66 g dimethylethanolamine, 75.34 g water was added into a flask and stir at 60 degree C. until it was completely dissolved and forming clear solution. The final polymer solution has pH of 8.79 and a concentration of ca. 20 wt. % in water.

### Example A

Black inks from self-dispersed carbon black dispersions of various volatile surface functional group.

### Ink Formulation

### Black Ink A1 of the Invention (I-A1)

To prepare the Ink I-A1, 34.6 g of self-dispersed carbon black dispersion Bonjet CW-3 from Orient Corp (13 wt % active), 5 g of diethylene glycol, 8 g of glycerol, 3 g of polyethylene glycol 400 (Dow Corp), 7.5 g of Strodex PK-90 surfactant solution from Dexter Chemical Corp. (Diluted to 2% wt), and 2.0 g of water soluble polymer A-2 solution (20% active) were added together with distilled water so that the final weight of the ink was 100.0 g. The final ink contained 4.5% carbon 5% diethylene glycol, 8% glycerol, 3% polyethylene glycol 400, 0.15% Strodex PK-90 and 0.4% water-soluble polymeric binder. The solution was filtered through a 1.2 μm polytetrafluoroethylene filter. The resulting ink had the following physical properties: a surface tension of 33 dynes/cm at room temperature, a viscosity of 1.8 cps at room temperature, and a pH of 7.6. The 50% and 95% particle sizes of the ink were about 96 nm and 190 nm as measured by MICROTRAC II Ultrafine particle analyzer (UPA) manufactured by Leeds & Northrup.

### Black Ink A2 of the Invention (I-A2)

Ink I-A2 of the present invention was prepared similarly to Ink I-A1 except that 22.5 of self-dispersed carbon black dispersion Aquablack 162 from Tokai Carbon Corp (20 wt % active) was added in place of Bonjet CW-3. The final ink contained 4.5% carbon 5% diethylene glycol, 8% glycerol, 3% polyethylene glycol 400, 0.15% Strodex PK-90 and 0.4% water-soluble polymeric binder A-2. The solution was filtered through a 1.2 μm polytetrafluoroethylene filter. The resulting ink had the following physical properties: a surface tension of 34 dynes/cm at room temperature, a viscosity of 1.8 cps at room temperature, and a pH of 7.4. The 50% and 95% particle sizes of the ink were about 130 nm and 194 nm as measured by MICROTRAC II Ultrafine particle analyzer (UPA) manufactured by Leeds & Northrup.

### Black Ink A3 of the Invention (I-A3)

Ink I-A3 of the present invention was prepared similarly to Ink I-A1 except that 22.5 of self-dispersed carbon black dispersion Aquablack 164 from Tokai Carbon Corp (20 wt % active) was added in place of Bonjet CW-3. The final ink contained 4.5% carbon 5% diethylene glycol, 8% glycerol, 3% polyethylene glycol 400, 0.15% Strodex PK-90 and 0.4% water-soluble polymeric binder A-2. The solution was filtered through a 1.2 μm polytetrafluoroethylene filter. The resulting ink had the following physical properties: a surface tension of 33.4 dynes/cm at room temperature, a viscosity of 1.8 cps at room temperature, and a pH of 7.4. The 50% and 95% particle sizes of the ink were about 147 nm and 222 nm as measured by MICROTRAC II Ultrafine particle analyzer (UPA) manufactured by Leeds & Northrup.

### Comparative Ink A1 (C-A1)

Comparative Ink C-A1 was prepared similarly to Ink: I-A1 except that 30 g of self-dispersed carbon black Cabojet 300 from Cabot Corp (15 wt % active) was added in place of Bonjet CW-3. The final ink contained 4.5% carbon 5% diethylene glycol, 8% glycerol, 3% polyethylene glycol 400, 0.15% Strodex PK-90 and 0.4% water soluble polymeric binder A-2. The solution was filtered through a 1.2 μm polytetrafluoroethylene filter. The resulting ink had the following physical properties: a surface tension of 30 dynes/cm at room temperature, a viscosity of 1.84 cps at room temperature, and a pH of 8.2. The 50% and 95% particle sizes of the ink were about 125 nm and 186 nm as measured by MICROTRAC II Ultrafine particle analyzer (UPA) manufactured by Leeds & Northrup.

### Comparative Ink A2 (C-A2)

Comparative Ink C-A2 was prepared similarly to ink I-A1 except that 30 g of a self-dispersed carbon black D1 from Cabot Corp (15 wt % active) was added in place of Bonjet CW-3. D1 is very similar to Cabojet 300, except that the amount of surface functional group has been increased due to higher treatment level. The final ink contained 4.5% carbon 5% diethylene glycol, 8% glycerol, 3% polyethylene glycol 400, 0.15% Strodex PK-90 and 0.4% water-soluble polymeric binder A-2. The solution was filtered through a 1.2 μm polytetrafluoroethylene filter. The resulting ink had the following physical properties: a surface tension of 30 dynes/cm at room temperature, a viscosity of 1.84 cps at room temperature, and a pH of 8.2. The 50% and 95% particle sizes of the ink were about 125 nm and 186 nm as measured by MICROTRAC II Ultrafine particle analyzer (UPA) manufactured by Leeds & Northrup.

### Plain Paper Performance Evaluation

Inks of the present invention were filled into printer compatible empty cartridges and printing was done with a Canon i960 thermal inkjet printer. A solid area of 1 inch by 1 inch at 100% dot coverage was printed at 2 pass, bi-directional mode on 6 plain papers. The Status A reflection densities of the printed patches of all the 6 papers were measured using a sectoring densitometry. Since the print density is very paper sensitive and the objective was to achieve the lowest paper to paper variability, three parameters were chosen to evaluate print quality attributes, especially paper to paper variability for each ink under evaluation. They were 1) Average print density across 6 papers, 2) Print density range (Maximum print density-minimum print density) among the 6 papers, and 3) minimum print density on the worst performing paper. They are listed in Table 1. The 6 papers used for evaluation were: 1) Georgia-Pacific inkjet Paper Catalog Number 214305N, 2) Kodak bright white inkjet paper, 3) Hewlett Packard Color inkjet paper, 4) Georgia-Pacific multi-purpose Catalog Number 214306, 5) Hammermill Copy Plus, and 6) Hewlett Packard Multipurpose paper.

TABLE 1
Dispersion functional groups properties and print quality
for inks in Example A

| | Carbon K dispersion | | | | |
|---|---|---|---|---|---|
| | properties | | | | |
| | Wt % | Wt % | | | |
| | volatile | volatile | Print Quality | | |
| | surface | lactonic | Average | | |
| | functional | functional | Print | Density | Minimal |
| Inks | group | group | Density | Range | Density |
| Inventive Ink | 14.6 | 8.0 | 1.33 | 0.25 | 1.20 |
| I-A1 | | | | | |
| Inventive Ink | 20.4 | 9.2 | 1.40 | 0.14 | 1.33 |
| I-A2 | | | | | |
| Inventive | 23.4 | 11.3 | 1.49 | 0.15 | 1.43 |
| Ink I-A3 | | | | | |
| Comparative | 5.0 | 2.7 | 1.26 | 0.49 | 1.01 |
| Ink C-A1 | | | | | |
| Comparative | 8.7 | 3.6 | 1.31 | 0.60 | 1.07 |
| Ink C-A2 | | | | | |

The above results showed that both the total Wt % volatile surface functional group as well as Wt % volatile lactonic functional group are important parameters of the carbon black dispersion properties in order to achieve excellent plain paper text quality. When the carbon black dispersions have greater than 11% total volatile surface functional groups and greater than 5% volatile lactonic functional groups as measured above, print density paper to paper variability is dramatically reduced.

### Example B

Black inks made from >11% surface functional groups self-dispersed carbon black do not show reduced density at the addition of water soluble polymer.

### Black Ink B1a of the Invention (I-B1a)

To prepare the Ink I-B1a, 34.6 g of self-dispersed carbon black dispersion Bonjet CW-3 from Orient Corp (13 wt % active), 5 g of diethylene glycol, 8 g of glycerol, 3 g of polyethylene glycol 400 (Dow Corp), 6.0 g of Strodex PK-90 surfactant from Dexter Chemical Corp. (Diluted to 2% wt), and 2.0 g of water soluble polymer A-1 (20% active) were added together with distilled water so that the final weight of the ink was 100.0 g. The final ink contained 4.5% carbon 5% diethylene glycol, 8% glycerol, 3% polyethylene glycol 400, 0.12% Strodex PK-90 and 0.4% water-soluble polymeric binder. The solution was filtered through a 1.2 μm polytetrafluoroethylene filter.

### Black Ink B1b of the Invention (I-B1b)

Ink I-B1b of the present invention was prepared similarly to Ink I-B1a except that none of the water-soluble polymer was added.

### Black Ink B2a of the Invention (I-B2a)

To prepare the Ink I-B2a, 22.5 g of self-dispersed carbon black dispersion Aquablack 162 from Tokai Carbon Corp (20 wt % active), 5 g of diethylene glycol, 8 g of glycerol, 3 g of polyethylene glycol 400 (Dow Corp), 5.0 g of Strodex PK-90 surfactant from Dexter Chemical Corp. (Diluted to 2% wt), and 2.5 g of water soluble polymer A-2 (20% active) were added together with distilled water so that the final weight of the ink was 100.0 g. The final ink contained 4.5% carbon 5% diethylene glycol, 8% glycerol, 3% polyethylene glycol 400, 0.1% Strodex PK-90 and 0.5% water-soluble polymeric binder. The solution was filtered through a 1.2 μm polytetrafluoroethylene filter.

### Black Ink B2b of the Invention (I-B2b)

Ink I-B2b of the present invention was prepared similarly to Ink I-B2a except that none of the water-soluble polymer was added.

### Comparative Ink (C-B1a)

To prepare the Ink C-B1a, 22.5 g of 26.7 g of self-dispersed carbon black Cabojet 300 from Cabot Corp (15 wt % active), 5 g of diethylene glycol, 10 g of glycerol, 10 g of Strodex PK-90 surfactant from Dexter Chemical Corp. (Diluted to 2% wt), and 6 g of water soluble polymer A-2 (20% active) were added together with distilled water so that the final weight of the ink was 100.0 g. The final ink contained 4.0% carbon 5% diethylene glycol, 10% glycerol, 0.2% Strodex PK-90 and 1.2% water soluble polymeric binder. The solution was filtered through a 1.2 μm polytetrafluoroethylene filter.

### Comparative Ink (C-B1b)

Ink C-B1b of the present invention was prepared similarly to Ink C-B1a except that none of the water-soluble polymer was added.

### Plain Paper Density Retaining Power Evaluation

Inks of example B were filled into printer compatible empty cartridges and printing was done with a Canon i960 thermal inkjet printer. A solid area of 1 inch by 1 inch at 100% dot coverage was printed at 2 pass, bi-directional mode on 6 plain papers. The Status A reflection densities of the printed patches of all the 6 papers were measured using a sectoring densitometry. Since the print density is paper sensitive, two parameters were chosen to evaluate print quality attributes of each ink-paper combination. They were 1) Average print density across 6 papers 2) Print density range (Maximum print density-minimum print density) among the 6 papers. The Plain Paper Density Retaining Power is then defined as the difference between the average print qualities for inks made with and without the selected possible density reduction agent in the ink. In this case, the (Ink a) is the ink with polymer and (Ink b) is the ink without polymer. The specific parameters used to characterize the Plain Paper Density Retaining Power is 1) Difference of the average print density difference over 6 papers for (Ink b) minus that for (Ink a), and 2) Difference of the print density range over 6 papers for (Ink b) minus that of (Ink a). They are listed in Table 2. The 6 papers used were the same as that in Example A.

TABLE 2
Dispersion functional groups properties and
Plain Paper Density Retaining Power for inks in Example B

| | | Carbon K dispersion | | | | Plain Paper Density | |
|---|---|---|---|---|---|---|---|
| | | properties | | | | Retaining Power | |
| | | Wt % | Wt % | Plain paper | | Difference | Difference |
| | | volatile | volatile | density | | in average | in density |
| | | surface | lactonic | Average | | density | range |
| | | functional | functional | Print | Density | Ink_a vs | Ink_a vs |
| Ink Set | | group | group | Density | Range | Ink_b | Ink_b |
| Inventive | Ink I- | 14.6 | 8.0 | 1.32 | 0.26 | 0.0 | 0.0 |
| Ink Set I-B1 | B1a | | | | | | |
| | Ink I- | | | 1.32 | 0.26 | | |
| | B1b | | | | | | |
| Inventive | Ink I- | 20.4 | 9.2 | 1.37 | 0.17 | 0.0 | −0.01 |
| Ink Set I-B2 | B2a | | | | | | |
| | Ink I- | | | 1.37 | 0.16 | | |
| | B2b | | | | | | |
| Comparative | Ink C- | 5.0 | 2.7 | 1.14 | 0.52 | 0.14 | −0.15 |
| Ink Set | B1a | | | | | | |
| C-B1 | Ink C- | | | 1.28 | 0.37 | | |
| | B1b | | | | | | |

The above results showed that both the total Wt % volatile surface functional group as well as Wt % volatile lactonic functional group are important parameters of the carbon black dispersion properties in order to increase the plain paper density retaining power. When the carbon black dispersions have greater than 11 wt % volatile total functional groups and 5% volatile lactonic functional groups, inks made from the dispersions showed much more density retaining power, thus less plain paper density reduction when selected density reducing components, e.g. water soluble polymer, is added into the ink. This greatly increased the ink formulation space and latitude, especially under conditions when these components are required for overall ink performance, such as jetting performance and print durability.

### Example C

Water-soluble polymer needs to be inorganic base neutralized for good jetting.

### Ink Formulation

### Black Ink C1 of the Invention (I-C1)

To prepare the Ink I-C1, 30.8 g of Bonjet CW-3 from Orient Corp (13 wt % active), 7 g of diethylene glycol, 11 g of glycerol, 0.9 g of polyethylene glycol 400 (Dow Corp), 6.0 g of Tergitol 15-s-12 surfactant from Dow Chemical Corp. (Diluted to 10% active), and 3.0 g of water soluble polymer A-1 (20% active) were added together with distilled water so that the final weight of the ink was 100.0 g. The final ink contained 4.0% carbon 7% diethylene glycol, 11% glycerol, 0.9% polyethylene glycol 400, 0.6% of Tergitol 15-s-12 and 0.6% KOH neutralized water soluble polymeric binder A-1. The solution was filtered through a 1.2 μm polytetrafluoroethylene filter.

### Black Ink C2 of the Invention (I-C2)

Ink I-C2 of the present invention was prepared simiilarly to Ink I-C1, except that 7.5 g of water-soluble polymeric binder A-1 was added. The final ink contained 4% carbon 7% diethylene glycol, 11% glycerol, 0.9% polyethylene glycol 400, 0.6% Tergitol 15-s-12 and 1.5% KOH neutralized water soluble polymeric binder A-1.

### Comparative Ink C1 (C-C1)

Comparative ink C-C1 of was prepared sinilarly to Ink I-C1, except that 3.0 g of water soluble polymeric binder A-3 was added instead of polymeric binder A-1. The final ink contained 4% carbon 7% diethylene glycol, 11% glycerol, 0.9% polyethylene glycol 400, 0.6% Tergitol 15-s-12 and 0.6% dimethylethanolamine neutralized water-soluble polymeric binder A-3.

### Comparative Ink C2 (C-C2)

Comparative ink C-C2 of was prepared similarly to Ink I-C2, except that 7.5 g of water-soluble polymeric binder A-3 was added. The final ink contained 4% carbon 7% dietylene glycol, 11% glycerol, 0.9% polyethylene glycol 400, 0.6% Tergitol 15-s-12 and 1.5% dimethylethanolamine neutralized water-soluble polymeric binder A-3.

### Jetting Performance Evaluation

Inks of the example C were evaluated on a drop performance fixture apparatus having a thermal printhead with 640 nozzles at 1200 dpi. The operating voltage for the printhead was held at about 12 percent over the threshold voltage (minimum voltage needed to cause ejection of an ink droplet) of the printhead. The transit time for a drop of ink traveling to a distance of 0.3 mm was recorded based on the signal captured by the laser detector. The drop velocity is then calculated based on the transit time. Under the above conditions, inks of the present inventions were fired at 10,000 Hz from 4 adjacent nozzles for up to 1.5E8 firing events. Drop velocity of all the four nozzles was measured at an interval of 1E6 firing events. Key parameters for evaluating the jetting performance of an ink include the following: 1) Drop velocity at operating voltage (12% over threshold voltage was used) during early printhead life (after 1E7 firing events), 2) Drop velocity at normal print life (after 5 E7 firing events), 3) The maximum number of firing drops before the printhead exhibits significant degradation, such as unstable drop formation or low velocity. These are shown in Table 3.

TABLE 3
Jetting Performance for Inks In Example C

| | Jetting Performance | | | |
|---|---|---|---|---|
| | | | % Velocity | Max |
| | Drop velocity | Drop velocity | drop from | drops firing |
| Inks | after 1E7 firing | after 5E7 firing | 1E7 to 5E7 | before failure |
| I-C1 | 17 m/s | 17 m/s | 0% | >1.5E8 |
| C-C1 | 9 m/s | 6.5 m/s | 27.8% | >1.5E8 |
| I-C2 | 13 m/s | 12.7 m/s | 2.3% | >1.5E8 |
| C-C2 | 6 m/s | 4 m/s | 33.3% | 7E7 |

The above results show that the black inks consisting of water soluble polymers neutralized by organic base showed significant poor jetting performance, which included the low drop velocity, high velocity drop over print life. This result is also consistent with the polymer levels. At higher polymer levels in the ink, the jetting performance degraded significantly, resulting in premature drop missing, most likely due to the interaction of the organic base neutralized polymeric binders with the thermal printhead heater surface.

### Example D

Water-soluble polymer is needed for reliable printing on the printer.

### Black Ink D1 of the Invention (I-D1)

To prepare the Ink I-D1, 22.5 g of self-dispersed carbon black dispersion Aquablack 162 from Tokai Carbon Corp (20 wt % active), 5 g of diethylene glycol, 8 g of glycerol, 3 g of polyethylene glycol 400 (Dow Corp), 2.5 g of Tergitol 15-s-12 surfactant from Dow Chemical Company (Diluted to 10% wt), and 2.0 g of water soluble polymer A-1 (20% active) were added togorether with distilled water so that the final weight of the ink was 100.0 g. The final ink contained 4.5% carbon 5% diethylene glycol, 8% glycerol, 3% polyethylene glycol 400, 0.25% Tergitol 15-s-12 and 0.4% water soluble polymeric binder. The solution was filtered through a 1.2 μm polytetrafluoroethylene filter.

### Black Ink D2 of the Invention (I-D2)

To prepare the Ink I-D2, 22.5 g of self-dispersed carbon black dispersion Aquablack 162 from Tokai Carbon Corp (20 wt % active), 5 g of diethylene glycol, 8 g of glycerol, 3 g of polyethylene glycol 400 (Dow Corp), 6 g of Strodex PK-90 (diluted to 2%), and 2.5 g of water soluble polymer A-2 (20% active) were added together with distilled water so that the final weight of the ink was 100.0 g. The final ink contained 4.5% carbon 5% diethylene glycol, 8% glycerol, 3% polyethylene glycol 400, 0.12% Strodex PK-90 and 0.5% water-soluble polymeric binder A-2.

### Black Ink D3 of the Invention (I-D3)

To prepare the Ink I-D3, 34.6 g of self-dispersed carbon black dispersion CW-3 from Orient Chemicals (13% active), 5 g of diethylene glycol, 8 g of glycerol, 3 g of polyethylene glycol 400 (Dow Corp), 4 g of Tergitol 15-s-12 surfactant from Dow Chemical Company (Diluted to 10% wt), and 2.0 g of water soluble polymer A-1 (20% active) were added together with distilled water so that the final weight of the ink was 100.0 g. The final ink contained 4.5% carbon 5% diethylene glycol, 8% glycerol, 3% polyethylene glycol 400, 0.4% Tergitol 15-s-12 and 0.4% water soluble polymeric binder A-1.

### Comparative Ink D1 (C-D1)

Comparative ink C-D1 of was prepared similarly to Ink I-D2, except that none of the water-soluble polymer was added.

### Comparative Ink D2 (C-D2)

Comparative ink C-D2 of was prepared similarly to Ink I-D3, except that none of the water-soluble polymer was added.

### System Text Printing Evaluation

Inks of example D were filled into printer compatible empty cartridges and printing was done using an experimental thermal desktop printer. The system testing prints a text document of 5% coverage to simulate typical consumer text printing. For every 40 pages of continuous printing, a nozzle check target was printed to evaluate nozzle health. The number of missing nozzles at each interval was recorded. Two parameters were used to evaluate the system printing performance: 1) Average number of nozzles missing after 600 pages of printing. 2) Number of pages printed before 20% of the nozzles failed to fire properly. The results are listed in Table 4.

TABLE 4
System Text Printing for Inks In Example D

| | Text Printing Performance | |
|---|---|---|
| | Average no of nozzles | No. of pages printed before 20% |
| Inks | missing after 600 pages | nozzles missing |
| I-D1 | 2.6 | >600 pages |
| I-D2 | 1.7 | >600 pages |
| I-D3 | 2.0 | >600 pages |
| C-D1 | 87 | 120 pages |
| C-C2 | 44 | 160 pages |

The above results show that the black inks consisting of water soluble polymers neutralized by inorganic base showed significantly improved text printing in a printer system. Without the polymer, printing performance was significantly degraded.

The invention has been described with reference to a preferred embodiment however it will be appreciated that variations and modifications can be effected by a person of ordinary skill in the art without departing from the scope of the invention.

1. An inkjet ink comprising water, a self-dispersing carbon black pigment, and a water soluble polymer containing acid groups neutralized by an inorganic base, wherein said carbon black pigment comprises greater than 11 weight % volatile surface functional groups.

2. An inkjet ink according to claim 1, wherein said carbon black pigment comprises greater than 15 weight % volatile surface functional groups.

3. An inkjet ink according to claim 1, wherein said carbon black pigment comprises greater than 18 weight % volatile surface functional group.

4. The ink of claim 1 wherein said self-dispersing pigment is anionically charged.

5. The ink of claim 4, wherein said self-dispersing pigment is neutralized by sodium, potassium, lithium or rubidium cation.

6. The ink of claim 1 wherein said self-dispersing pigment comprises greater than 5 weight % volatile lactonic surface functional group content.

7. The ink of claim 1 further comprising at least one humectant.

8. The ink of claim 1 further comprising at least one surfactant.

9. The ink of claim 1 wherein 50 weight % of the pigment particles have a particle size of less than 500 microns.

10. The ink of claim 1 wherein 50 weight % of the pigment particles have a particle size of less than 200 nm.

11. The ink of claim 1 wherein the total amount of pigment is 0.1 weight % to 6.0 weight % of the ink.

12. The ink of claim 1 wherein said water soluble polymer has a number average molecular weight of 3000 to 10000.

13. The ink of claim 1 wherein said water soluble polymer has a acid number of 100 to 350.

14. The ink of claim 1 wherein 75 to 100% of the acid groups on the polymer are neutralized by alkaline metal hydroxide.

15. The ink of claim 14 wherein the alkaline metal hydroxide is lithium hydroxide, sodium hydroxide or potassium hydroxide, or a mixture thereof.

16. The ink of claim 1 wherein said inorganic base comprises an alkaline metal hydroxide.

17. An inkjet printing method comprising the steps of:
a) providing an inkjet printer that is responsive to digital data signals;
b) loading said printer with an inkjet recording element;
c) loading said printer with an aqueous inkjet ink composition of claim 1; and
d) applying said inkjet ink composition to said inkjet recording element in response to said digital data signals.

18. The method of claim 17 wherein said printer is a thermal inkjet printer.

19. An inkjet ink set comprising distinct cyan, magenta, yellow and black inks, wherein at least one ink of the ink set comprises an ink of claim 1.
